(19) United States
(12) Patent Application Publication
(10) Pub. No.: US 2025/0170974 A1
(43) Pub. Date: May 29, 2025

(54) POWER SUPPLY SYSTEM

(71) Applicant: TOYOTA JIDOSHA KABUSHIKI KAISHA, Toyota-shi (JP)

(72) Inventor: Takaya Koshii, Nagoya-shi (JP)

(73) Assignee: TOYOTA JIDOSHA KABUSHIKI KAISHA, Toyota-shi (JP)

(21) Appl. No.: 18/938,769

(22) Filed: Nov. 6, 2024

(30) Foreign Application Priority Data
Nov. 24, 2023 (JP) 2023-198882

(51) Int. Cl. B60R 16/03; B60L 50/60; B60L 58/20

(52) U.S. Cl. CPC B60R 16/03; B60L 50/66; B60L 58/20; B60L 2210/12; B60L 2260/32

(57) ABSTRACT

A power supply system mounted on a vehicle includes: a first power supply for supplying power to a load; a second power supply capable of backing up the first power supply; a measurement unit for measuring a discharge amount of the second power supply; and a control unit for controlling a load of a power supply destination of the second power supply, wherein when the first power supply fails, the control unit supplies power of the second power supply to the first load until the discharge amount reaches a predetermined threshold value, and switches the power supply destination of the second power supply to the second load after the discharge amount reaches a predetermined threshold value.

### CROSS-REFERENCE TO RELATED APPLICATION

This application claims priority to Japanese Patent Application No. 2023-198882 filed on Nov. 24, 2023, incorporated herein by reference in its entirety.

### BACKGROUND

### 1. Technical Field

The present disclosure relates to a power supply system that controls power supply by a plurality of power supplies mounted on a vehicle.

### 2. Description of Related Art

Japanese Unexamined Patent Application Publication No. 2020-156228 (JP 2020-156228 A) discloses a control device that controls a sub-power supply capable of backing up a main power supply during autonomous driving. It is described that this control device permits the autonomous driving when determination is made that the sub-power supply can output backup power necessary in a limp home mode of the autonomous driving based on the state of the sub-power supply estimated in a period of manual driving after ignition is turned on.

### SUMMARY

In general, the backup power of the sub-power supply necessary in the limp home mode when the main power supply fails during the autonomous driving is predefined by the maximum current pattern (electric power) necessary in the limp home mode. However, the possibility of lack of this defined backup power is not zero in the actual limp home mode. It is conceivable to transfer authority from the autonomous driving by the system to non-autonomous driving by the driver in order to complete the limp home mode to the end even when the backup power is insufficient. This transfer of authority requires control of switching of power supply to an appropriate load.

The present disclosure provides a power supply system capable of supplying electric power from a sub-power supply to an appropriate load when a main power supply fails.

In order to address the above issue, an aspect of the technology of the present disclosure is a power supply system to be mounted on a vehicle. The power supply system includes:
a first power supply configured to supply electric power to a load;
a second power supply configured to back up the first power supply;
a measurement unit configured to measure a discharge amount of the second power supply; and
a control unit configured to control the load that is a power supply destination of the second power supply.
   The control unit is configured to, when the first power supply fails:
supply electric power of the second power supply to a first load until the discharge amount reaches a predetermined threshold value; and
switch the power supply destination of the second power supply to a second load after the discharge amount reaches the predetermined threshold value.

In the power supply system of the present disclosure, the load that is the power supply destination is switched by monitoring the discharge amount of the second power supply. Therefore, it is possible to supply electric power to an appropriate load depending on the discharge amount of the second power supply when the first power supply fails.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block-diagram of a power supply system and a peripheral portion thereof according to an embodiment of the present disclosure; and

FIG. 2 is a processing flowchart of power supply control when a power supply failure is executed by the power supply system.

### DETAILED DESCRIPTION OF EMBODIMENTS

A power supply system according to the present disclosure has a function of measuring a discharge amount of a sub power supply redundantly provided for backing up a main power supply. With this function, it is possible to appropriately switch a load that supplies electric power in accordance with the discharge amount of the sub power supply in a case where the main power supply fails.

Hereinafter, an embodiment of the present disclosure will be described in detail with reference to the drawings.

### Embodiment

### Configuration

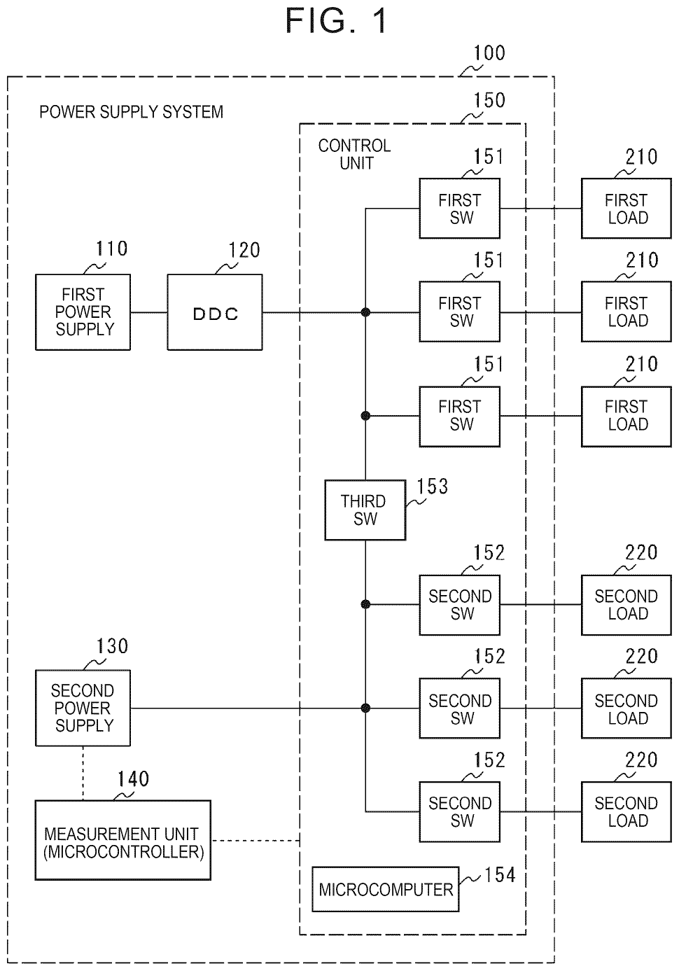

FIG. 1 is a functional block diagram of a power supply system 100 and a peripheral portion thereof according to an embodiment of the present disclosure. The functional block illustrated in FIG. 1 includes a power supply system 100, a plurality of first loads 210, and a plurality of second loads 220. The power supply system 100 includes a first power supply 110, a DCDC converter (DDC) 120, a second power supply 130, a measurement unit 140, and a control unit 150. The control unit 150 includes a plurality of first switches (SW) 151, a plurality of second switches (SW) 152, a third switch (SW) 153, and a microcomputer 154.

The power supply system 100, the plurality of first loads 210, and the plurality of second loads 220 may be mounted on a vehicle. Note that the number of the first loads 210 and the number of the second loads 220 mounted on the vehicle is not limited to the illustrated number.

The first power supply 110 is a power supply source for supplying power to the first load 210 and the second load 220 via DCDC converter 120 and the control unit 150. The first power supply 110 is a secondary battery configured to be chargeable and dischargeable, such as a lithium-ion battery. A high-voltage LiB (lithium-ion battery) can be exemplified as the first power supply 110 in vehicles.

DCDC converter 120 is provided between the first power supply 110 and the control unit 150. DCDC converter 120 is a voltage converter for converting a voltage of the first power supply 110 to be inputted into a voltage required for the first load 210 and the second load 220, and outputting the voltage to the first load 210 and the second load 220 via the control unit 150. DCDC converter 120 is connected to a connecting point between the first switch 151 and the third switch 153 of the control unit 150. DCDC converter 120 may be, for example, a step-down DCDC converter that steps down the voltage of the first power supply 110.

The second power supply 130 is a power supply source for supplying power to the first load 210 and the second load 220. The second power supply 130 is a rechargeable battery such as a lithium-ion battery. The second power supply 130 is connected to a connection point between the second switch 152 and the third switch 153 of the control unit 150. As the second power supply 130 in vehicles, an auxiliary LiB (lithium-ion battery) having a lower voltage than that of the high-voltage LiB can be exemplified.

The measurement unit 140 is a configuration for measuring the state of the second power supply 130, and is typically a microcomputer. The measurement unit 140 can measure the discharging amount [Ah] which is the amount of current emitted from the second power supply 130 toward the first load 210 and the second load 220 as the second power supply 130. For this measurement, a detection device such as a voltage sensor or a current sensor is used. Note that, although the measurement unit 140 is configured independently of the second power supply 130, it may be incorporated in the second power supply 130.

The control unit 150 is configured to control a state of supplying power to the first load 210 and the second load 220 in the power supply system 100 (B-DC).

The first switch 151 is a switch element (such as a semiconductor switch) capable of switching between an electrically conductive state and a disconnected state under the control of the microcomputer 154. The first switch 151 is inserted between the first power supply 110 and the first load 210 via DCDC converter 120.

The second switch 152 is a switch element (such as a semiconductor switch) capable of switching between an electrically conductive state and a disconnected state under the control of the microcomputer 154. The second switch 152 is inserted between the second power supply 130 and the second load 220.

The third switch 153 is a switch element (such as a semiconductor switch) capable of switching between an electrically conductive state and a disconnected state under the control of the microcomputer 154. The third switch 153 is inserted at a position connecting the plurality of first loads 210 and the plurality of second loads 220.

The microcomputer 154 controls (switches) the conduction/disconnection states of the first switch 151, the second switch 152, and the third switch 153 based on the presence/absence of a failure in the first power supply 110 and the discharge amount of the second power supply 130. The occurrence of a power failure in the first power supply 110 may be detected (determined) based on information (current, voltage, etc.) outputted from DCDC converter 120. Further, the discharge amount of the second power supply 130 can be acquired from the measurement unit 140.

The first load 210 is a load that operates using the first power supply 110 as a power source. The first load 210 includes a load (in-vehicle device) that realizes a function related to autonomous driving that requires a redundant power supply configuration.

The second load 220 is a load that operates using the first power supply 110 as a power source when the first power supply 110 is normal, and can operate using the first power supply 110 or the second power supply 130 as a power source when the first power supply 110 fails. The second load 220 includes a load (in-vehicle device) that realizes a function related to non-autonomous driving.

### Control

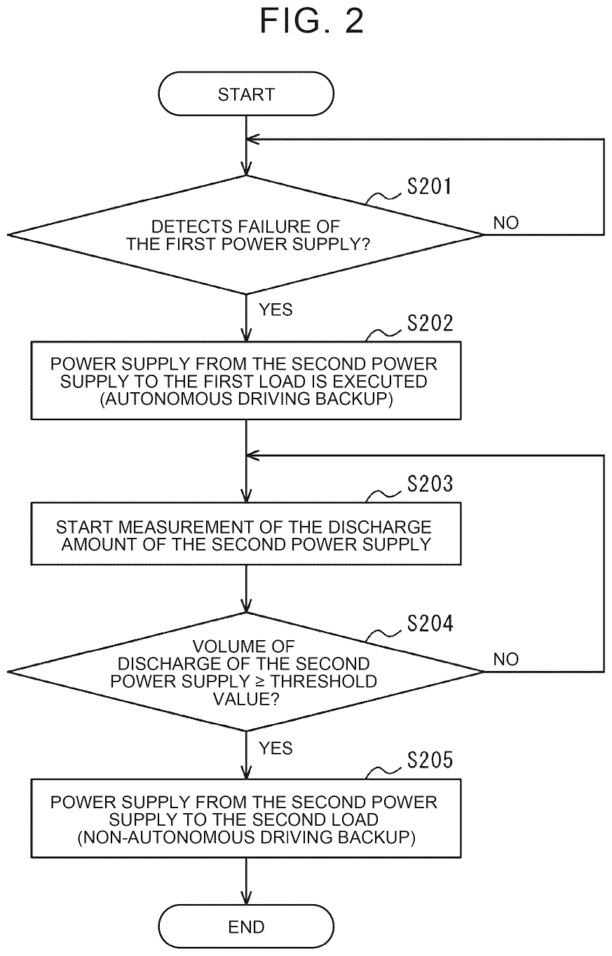

Next, the operation of the power supply system 100 according to the present embodiment will be described with further reference to FIG. 2. FIG. 2 is a flowchart for explaining a processing procedure of power supply control at the time of power supply failure executed by the measurement unit 140 and the control unit 150 of the power supply system 100. The power supply control in the case of the power failure illustrated in FIG. 2 is started when the vehicle performs the autonomous driving.

### S201

The control unit 150 determines whether or not a failure of the first power supply 110 has been detected. This determination may be based on the power of DCDC converter 120. The control unit 150 notifies the measurement unit 140 that the failure of the first power supply 110 has been detected. When the control unit 150 detects a failure of the first power supply 110 (S201, Yes), the process proceeds to S202.

### S202

The control unit 150 controls the conduction/disconnection states of the first switch 151, the second switch 152, and the third switch 153 to supply power from the second power supply 130 to the first load 210. By this control, the power supply to the function related to the autonomous driving is continuously performed, and the backup travel (specifically, the travel in the limp home mode) initiated by the system is started (autonomous driving backup). When the control unit 150 supplies electric power from the second power supply 130 to the first loads 210, the process proceeds to S203.

### S203

The measurement unit 140 starts measurement of the discharge amount of the second power supply 130. The discharge amount measured by the measurement unit 140 is an integrated value of electric power supplied from the second power supply 130 to the first load 210 after the autonomous driving backup is started. When the measurement unit 140 starts measuring the discharging quantity of the second power supply 130, the process proceeds to S204.

### S204

The control unit 150 determines whether the discharge amount of the second power supply 130 measured by the measurement unit 140 is equal to or greater than a predetermined threshold value. This determination is made in order to determine the timing at which the driving authority of the travel in the limp home mode is transferred from the system to the driver. Further, the predetermined threshold value is set based on a maximum current pattern (current, time) required during the travel in the limp home mode. When the control unit 150 determines that the discharging amount of the second power supply 130 is equal to or greater than the threshold value (S204, Yes), the process proceeds to S205. When the discharge amount of the second power supply 130 becomes equal to or larger than the threshold value, the measurement unit 140 notifies the control unit 150. This notification may be made, for example, by turning ON a predetermined flag (automatic→non-automatic backup switching flag or the like). On the other hand, if the control unit 150 determines that the discharging rate of the second power supply 130 is not equal to or greater than the threshold value (S204, No), the process proceeds to S203.

### S205

The control unit 150 controls the conduction/disconnection states of the first switch 151, the second switch 152, and the third switch 153 to supply power from the second power supply 130 to the second load 220. That is, the control unit 150 switches the power supply destination from the second power supply 130 from the first load 210 to the second load 220 to execute the power supply. The switching of the power supply destination can be performed, for example, by the control unit 150 detecting that the predetermined flag is turned ON. By this control, the power supply destination is switched from the function related to the autonomous driving to the function related to the non-autonomous driving, and the operation authority is transferred from the system to the driver, and the travel in the limp home mode led by the driver is started (non-autonomous driving backup). When the control unit 150 executes the power supply from the second power supply 130 to the second load 220, the power supply control at the time of the power supply failure ends.

In FIG. 1, a configuration has been described in which the first load 210 that performs power supply from the second power supply 130 during autonomous driving backup is connected to the first power supply 110 side. However, when the effect caused by the failure of the first power supply 110 reaches the control unit 150 through DCDC converter 120, it is preferable to shut off the third switch 153 and electrically completely disconnect the first power supply 110 from the second power supply 130. In this way, when the first power supply 110 is completely electrically disconnected from the second power supply 130 when the first power supply 110 fails, it is conceivable that a load for realizing a function related to autonomous driving, which is a target of autonomous driving backup, is configured as a part of the second load 220 side, and a load for realizing a function related to non-autonomous driving, which is a target of non-autonomous driving backup, is configured as another part of the second load 220 side. In such a configuration, by appropriately controlling the conduction/disconnection state of the second switch 152, it is possible to appropriately switch the load that supplies electric power in accordance with the discharge amount of the second power supply 130.

### Operations and Effects

As described above, according to the power supply system 100 according to an embodiment of the present disclosure, when the first power supply 110 fails, the discharge amount of the second power supply 130 is monitored. The electric power of the second power supply 130 is supplied to the first load 210 until the discharge amount of the second power supply 130 reaches the threshold value. After that, after the discharge amount of the second power supply 130 reaches the threshold value, control is performed to switch the power supply destination of the second power supply 130 from the first load 210 to the second load 220.

By this control, if the current consumed by the first load 210 in the actual backup travel (travel in the limp home mode) is less than the maximum current pattern defined by the autonomous driving backup, the period in which power is supplied to the first load 210 can be lengthened. As a result, it is possible to reduce the burden of the driver on the travel in the limp home mode. In addition, if the current consumed by the first load 210 during the actual travel in the limp home mode is larger than the maximum current pattern defined by the autonomous driving backup, the period for supplying power to the first load 210 can be shortened. This makes it possible to expect the driver to complete the travel in the limp home mode.

Although the embodiments of the present disclosure have been described above, the present disclosure can be regarded as not only a power supply system but also a control method performed by the power supply system, a program of the control method, a computer-readable non-transitory storage medium storing the program, a vehicle including the power supply system, and the like.

The power supply system of the present disclosure can be used for power supply control of a vehicle or the like equipped with a first power supply that supplies power to a load and a second power supply that can back up the first power supply.

What is claimed is:

1. A power supply system to be mounted on a vehicle, the power supply system comprising:
a first power supply configured to supply electric power to a load;
a second power supply configured to back up the first power supply;
a measurement unit configured to measure a discharge amount of the second power supply; and
a control unit configured to control the load that is a power supply destination of the second power supply, wherein the control unit is configured to, when the first power supply fails,
supply electric power of the second power supply to a first load until the discharge amount reaches a predetermined threshold value, and
switch the power supply destination of the second power supply to a second load after the discharge amount reaches the predetermined threshold value.

2. The power supply system according to claim 1, wherein:
the first load is a load configured to implement a function related to autonomous driving;
the second load is a load configured to implement a function related to non-autonomous driving; and
the predetermined threshold value is set based on a timing for transferring authority of driving from a system to a driver when the first power supply fails during the autonomous driving of the vehicle.

3. The power supply system according to claim 2, wherein the timing is a timing at which electric power for completing a predetermined travel in a limp home mode by the driver remains in the second power supply.
